(19) United States
(12) Patent Application Publication
(10) Pub. No.: US 2009/0298452 A1
(43) Pub. Date: Dec. 3, 2009

(54) METHOD FOR SCANNING FREQUENCY, RECEIVER, AND COMPUTER-READABLE RECORDING MEDIUM

(75) Inventor: Futoshi Ota, Osaka (JP)

Correspondence Address: BAKER & MCKENZIE LLP;PATENT DEPARTMENT, 2001 ROSS AVENUE, SUITE 2300, DALLAS, TX, 75201, US

(73) Assignee: ICOM INCORPORATED, Osaka (JP)

(21) Appl. No.: 12/473,625

(22) Filed: May 28, 2009

(30) Foreign Application Priority Data
May 30, 2008 (JP) 2008-143932

(51) Int. Cl. H04B 1/18

(52) U.S. Cl. 455/161.1

(57) ABSTRACT

A receiver according to the present invention has a reception unit which receives reception signals; a storage unit which stores a band table, in which a plurality of frequency bands serving as scanning targets are registered so that the frequency bands correspond to band identifiers, respectively, and a link table, in which any number of the band identifiers registered in the band table are registered so that the band identifiers correspond to a link identifier; a control unit which, when the link identifier is specified, refers to the band table and the link table, obtains the frequency bands corresponding to the link identifier, carries out scanning within the frequency band for each of the frequency bands, and sequentially sets reception frequencies of the reception signals; and a frequency synthesizer.

### BACKGROUND OF THE INVENTION

1. Field of the Invention

The present invention relates to a method for scanning frequency particularly used in a wide-band receiver or the like, a receiver using the same, and a computer-readable recording medium storing a program.

2. Description of the Related Art

Wide-band receivers and the like employ the scanning method in which signals are received while reception frequencies are sequentially changed.

Techniques related to the related method for scanning frequency are shown in Examined Japanese Utility Model Application KOKOKU Publication No. H07-037385 (hereinafter, referred to as Patent Literature 1) and U.S. Pat. No. 5,710,992 (hereinafter, referred to as Patent Literature 2).

Patent Literature 1 proposes a method which efficiently scans many frequencies by collectively storing a plurality of frequencies, which are serving as scanning targets, in a memory as a bank and carrying out scanning for each bank.

However, this method has a problem that frequency bands (bandwidth) cannot be scanned.

On the other hand, in Patent Literature 2, a band table in which upper-limit frequencies and lower-limit frequencies of bands serving as scanning targets are written is provided and a memory area to which a code indicating that whether scanning is to be executed or not is written is provided for each band of the band table so that frequency bands can be scanned. Then, merely the band to which the code that enables execution of scanning is attached is selected to carry out frequency scanning. According to this method, merely desired frequency bands can be scanned among a wide band by writing the codes that enable execution of scanning.

According to the method for scanning frequency of above-described Patent Literature 2, merely the required frequency band can be subjected to frequency scanning among a wide band. However, every time the band serving as scanning target is changed, the codes indicating that whether scanning is to be executed or not have to be rewritten.

Therefore, it is an object of the present invention to provide a method for scanning frequency, a receiver, and a recording medium capable of readily carrying out scanning of a plurality of patterns.

### SUMMARY OF THE INVENTION

One aspect of the present invention is a receiver comprising:

a reception unit receiving a signal;

a storage unit storing a band table, in which a plurality of frequency bands serving as scanning targets are registered so that the frequency bands correspond to band identifiers, respectively, and a link table, in which any number of the band identifiers registered in the band table are registered so that the band identifiers correspond to a link identifier; and

a scanning unit which, when the link identifier is specified, refers to the band table and the link table, obtains any number of frequency bands corresponding to the link identifier, sets a reception frequency of the reception unit within each of the frequency bands, and carries out scanning for each of the frequency bands.

Another aspect of the present invention is a method for scanning frequency which scans a desired frequency band, the method including:

referring to a band table, in which a plurality of frequency bands serving as scanning targets are registered so that the frequency bands correspond to band identifiers, respectively, and a link table, in which any number of the band identifiers registered in the band table are registered so that the band identifiers correspond to a link identifier; and,

when the link identifier is specified, obtaining the frequency bands corresponding to the link identifier and carrying out scanning within the frequency band for each of the frequency bands.

Another aspect of the present invention is a method for scanning frequency executed by a receiver having a reception unit, a storage unit, and a scanning unit, the method including:

a reception step of receiving a signal received by the reception unit;

a storage step of storing a band table, in which a plurality of frequency bands serving as scanning targets are registered so that the frequency bands correspond to band identifiers, respectively, and a link table, in which any number of the band identifiers registered in the band table are registered so that the band identifiers correspond to a link identifier, the storage step carried out by the storage unit; and

a scanning step of, when the link identifier is specified, referring to the band table and the link table, obtaining any number of frequency bands corresponding to the link identifier, setting a reception frequency of the reception unit within each of the frequency bands, and carrying out scanning for each of the frequency bands, the scanning step carried out by the scanning unit.

Another aspect of the present invention is a computer-readable recording medium recording a program which causes a computer to function as:

a reception unit receiving a signal;

a storage unit storing a band table, in which a plurality of frequency bands serving as scanning targets are registered so that the frequency bands correspond to band identifiers, respectively, and a link table, in which any number of the band identifiers registered in the band table are registered so that the band identifiers correspond to a link identifier; and

a scanning unit which, when the link identifier is specified, refers to the band table and the link table, obtains any number of frequency bands corresponding to the link identifier, sets a reception frequency of the reception unit within each of the frequency bands, and carries out scanning for each of the frequency bands.

### BRIEF DESCRIPTION OF THE DRAWINGS

These objects and other objects and advantages of the present invention will become more apparent upon reading of the following detailed description and the accompanying drawings in which:

FIG. 1 is a configuration diagram showing a receiver of a communication device according to an embodiment of the present invention;

FIG. 2 is an explanatory drawing showing an outline of a band table;

FIG. 3 is an explanatory drawing showing an outline of a link table; and

FIG. 4 is a flow chart showing a method for scanning frequency using the band table and the link table.

### DETAILED DESCRIPTION OF THE PREFERRED EMBODIMENT

Hereinafter, an embodiment of the present invention will be explained in detail based on drawings.

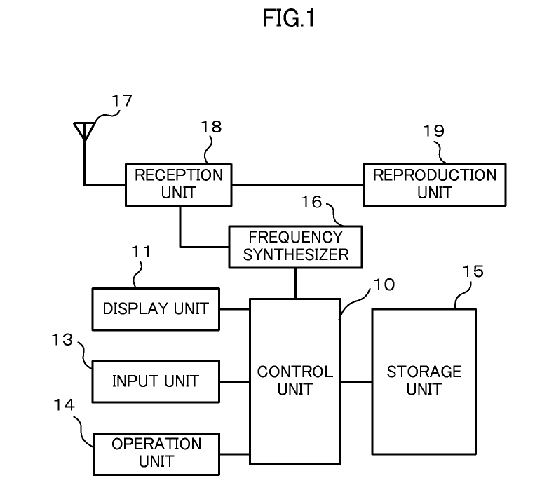

FIG. 1 is a configuration diagram showing a receiver according to the embodiment of the present invention.

The receiver has: a control unit 10, which comprises a Central Processing Unit (CPU) or the like and controls the operations of the entire receiver; a display unit 11; an input unit 13, which comprises various keys, etc. and inputs information to the control unit 10; an operation unit 14 by which a user inputs instructions to the control unit 10; a storage unit 15, which comprises a Random Access Memory (RAM) connected to the control unit 10 and stores a band table and a link table described later; a frequency synthesizer 16, which generates the frequencies specified by the control unit 10; a reception unit 18, which receives reception signals via an antenna 17 in the frequencies given by the frequency synthesizer 16; and a reproduction unit 19, which converts the signals output by the reception unit 18 to audible signals and outputs them.

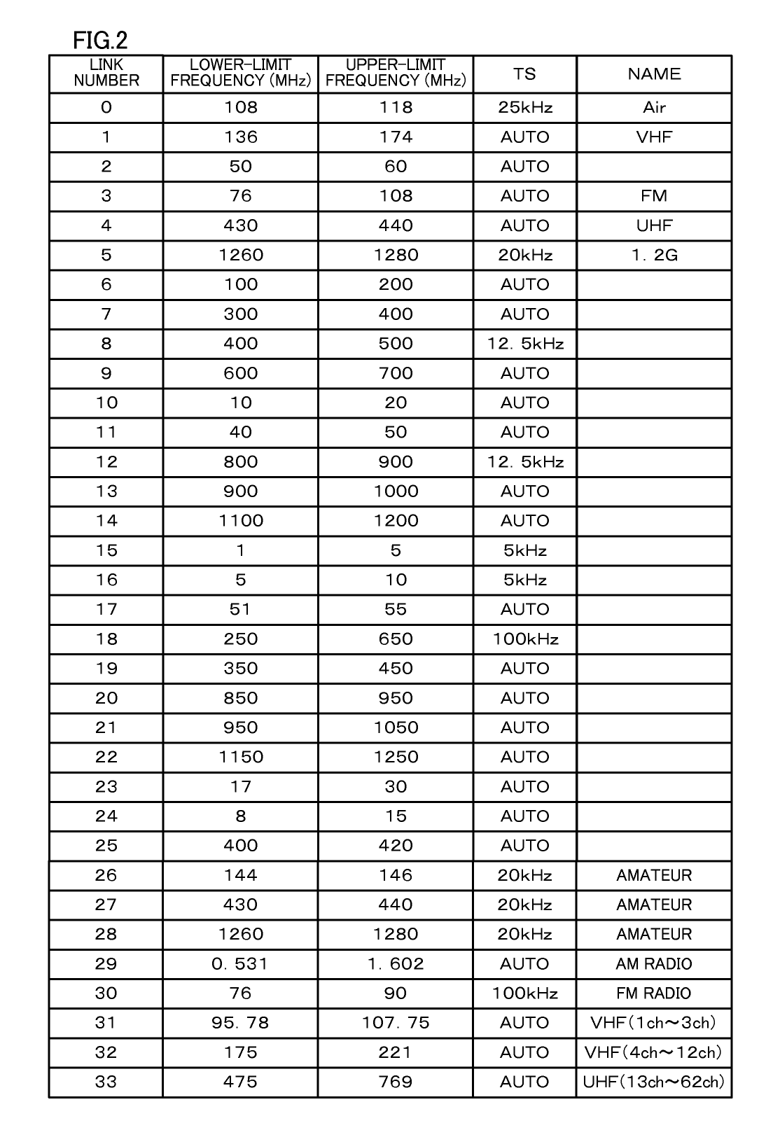

FIG. 2 is an explanatory drawing showing an outline of the band table.

The band table stored in the storage unit 15 specifies the frequency bands desired to be scanned by the user and, as shown in FIG. 2, stores lower-limit frequencies and upper-limit frequencies of the frequency bands desired to be scanned by the user in a manner that the upper and lower-limit frequencies correspond to link numbers serving as band identifiers. The frequency bands stored in the band table may be, for example, the frequency bands divided by 100 MHz like the link numbers 6 to 9 and 12 to 14 of FIG. 2 or may be registered depending on uses such as amateur bands, an AM band, a FM band, VHF (1 ch to 3 ch), VHF (4 ch to 12 ch), UHF (13 ch to 62 ch) like the link numbers 26 to 33. The frequency bands registered in the band table may overlap. In order to receive the reception signal of any frequency of the frequency bands by the reception unit 18, the control unit 10 refers to the band table and gives frequency data specifying the frequency to be generated by the frequency synthesizer 16 to the frequency synthesizer 16.

In addition, tuning steps (hereinafter, referred to as TS) specifying the step widths of the frequencies for carrying out scanning and names (NAME) are registered in the band table.

For example, if the lower-limit frequency, the upper-limit frequency, and TS of a frequency band are 10 MHz, 50 MHz, and 20 kHz, respectively, scanning is carried out at every 20 kHz between 10 MHz and 50 MHz.

In the storage unit 15, TS is initially set for each frequency band. For example, in the case of 531 kHz to 1602 kHz which is a frequency band of an AM radio, TS is initially set to 9 kHz. In the case of VHF (1 ch to 3 ch), VHF (4 ch to 12 ch), and UHF (13 ch to 62 ch), 6 MHz is initially set.

When AUTO mode is set as TS in the band table, these initially set TS are applied. Arbitrary tuning steps can be registered as TS of respective link numbers. When a plurality of frequency bands are to be collectively scanned, scan widths can be set for the frequency bands, respectively.

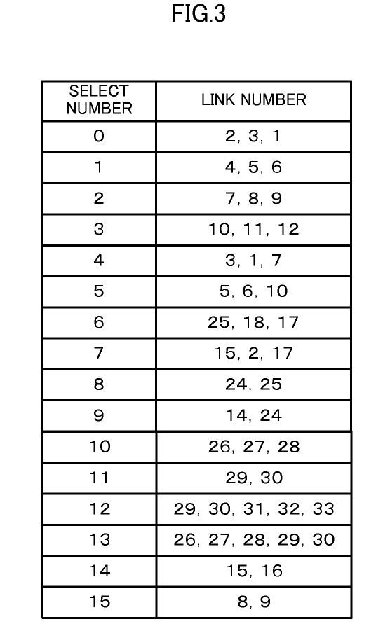

FIG. 3 is an explanatory drawing showing an outline of the link table.

The link table stored in the storage unit 15 specifies any number of frequency bands, which are to be collectively scanned, in the order of scanning and, as shown in FIG. 3, stores any number of link numbers, which represent the frequency bands, respectively, in a manner that the link numbers correspond to select numbers serving as link identifiers. These link numbers in the link table are the link numbers stored in the band table. When any of the select numbers is specified, a group of the link numbers representing the frequency bands for carrying out scanning is selected.

Note that the frequency bands corresponding to each select number are not limited to be plural, and merely one frequency band may be stored in a manner that the frequency band corresponds to one select number. In this case, when the select number is specified, one link number is selected.

The link numbers registered in association with the select numbers in the link table can be freely registered in accordance with the preference of the user.

When wide frequency bands are desired to be scanned successively, for example, when 1 MHz to 10 MHz are desired to be scanned, as shown in FIG. 3, the link numbers 15 and 16 may be registered as the select number 14.

A plurality of link numbers may be registered for one select number for each use. For example, like the select number 10, the frequency bands of three amateur radio bands may be collectively registered for one select number. Like the select number 11, the frequency band of the AM broadcast and the frequency band of the FM broadcast may be collectively registered for one select number. Like the select number 13, the frequency bands of three amateur radio bands, the frequency band of the AM broadcast, and the frequency band of the FM broadcast may be collectively registered for one select number.

Since the link numbers can be freely registered in this manner with respect to the select numbers of the link table in accordance with the preference of the user, a plurality of patterns of scanning that is carried out in desired frequency bands can be provided.

Registration to the band table and the link table is carried out by the user beforehand.

When registration to the band table and the link table is to be carried out, the user notifies the control unit 10 that the registration is to be carried out by using the operation unit 14. The control unit 10 causes the display unit 11 to display a screen that supports registering, and the user inputs information, which is to be stored in the band table and the link table, based on the display by using the keys, etc. of the input unit 13.

The control unit 10 stores the information, which is input by the input unit 13, in the band table and the link table. Note that the information to be stored in the band table and the link table may be input by a personal computer by connecting the personal computer or the like without using the keys of the input unit 13.

The link numbers to be stored in the link table in the manner that the link numbers correspond to the select numbers are written in the link table in the input order. Frequency scanning is carried out, for example, in this written order.

When the link numbers in the link table are to be registered with respect to the select numbers of the link table, the link numbers may be input in the order from a lower frequency band like the select number 1, the select number 2, and the select number 3; the link numbers may be input in the order from a high frequency band like the select number 6; or the frequency bands of the same use may be collectively input like the select number 12 and the select number 13.

Herein, frequency scanning can be also carried out in a desired order instead of the written order in the link table.

For example, in the case of the select number 1 of FIG. 3, frequency scanning can be carried out in the order of the link number 4 (430 MHz to 440 MHz), the link number 5 (1260 MHz to 1280 MHz), and the link number 6 (100 MHz to 200 MHz), which is the input order; or frequency scanning can be also carried out in the order of the link number 6, the link number 4, and the link number 5 by sorting the frequency bands in the ascending order of the frequencies.

On the other hand, frequency scanning can be also carried out in the order of the link number 5, the link number 4, and the link number 6 by sorting the frequency bands in 10 the descending order of the frequencies. The determination that whether the frequency bands are higher or lower than one another may be based on the upper-limit frequencies or the lower-limit frequencies of the frequency bands or may be based on center frequencies of the frequency bands, wherein the center frequencies are calculated from the upper-limit frequencies and the lower-limit frequencies thereof.

Even after the link numbers are once stored in the link table, the order of scanning can be changed. The timing of sorting is not limited to the point when the link numbers are stored in the link table, and the sorting can be carried out when scanning is to be started after the link numbers are once stored in the link table.

When sorting is employed, the link numbers can be sorted in the descending order or the ascending order to carry out scanning. For example, even when the link number 10, the link number 20, the link number 1, and the link number 5 are registered in the described order, the numbers can be sorted in the ascending order of the numbers to carry out scanning in the order of the link number 1, the link number 5, the link number 10, and the link number 20; or the numbers can be sorted in the descending order of the numbers to carry out scanning in the order of the link number 20, the link number 10, the link number 5, and the link number 1.

Furthermore, regardless of the input order, a desired order of scanning can be instructed. When the select number 1 is taken as an example, the order can be specified so that scanning is carried out in the order of the link number 5, the link number 4, and the link number 6.

In order to prevent redundantly scanning the same frequency band in one time of scanning, a configuration of prohibiting registration of overlapping link numbers which are tried to be registered when link numbers are to be registered in the link table may be employed. When such configuration is employed, redundantly registering the same frequency band can be prevented even when many link numbers are organized with respect to one select number; therefore, the same frequency band is not redundantly scanned in one time of scanning.

On the other hand, when a desired frequency band is desired to be intensively scanned, a configuration that enables registration of the same link numbers with respect to one select number may be employed. For example, the frequency band of the link number 1 can be intensively scanned by registering the link number 1, the link number 2, the link number 1, the link number 3, the link number 1, and the link number 4 with respect to one select number and carrying out scanning in this order. Such configuration is employed when a plurality of frequency bands are to be scanned, and this configuration is very effective when a particular frequency band(s) has to be intensively scanned.

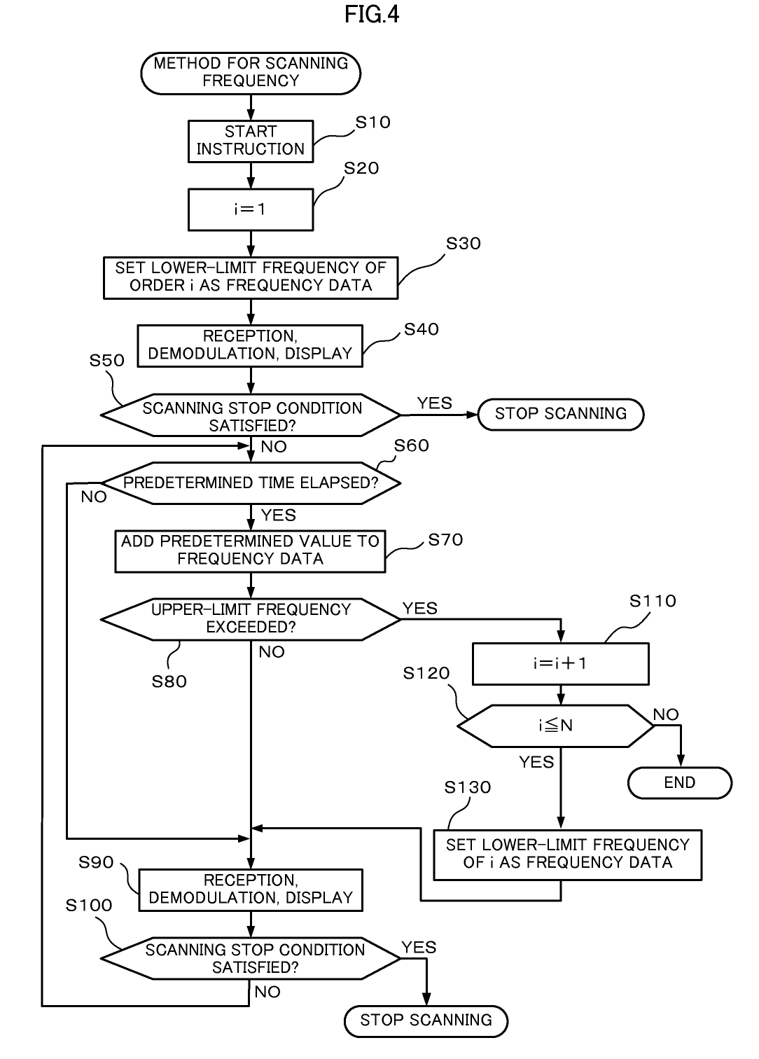

Next, a method for scanning frequency carried out by this receiver will be explained with reference to FIG. 4.

FIG. 4 is a flow chart showing the method for scanning frequency using the band table and the link table.

When the method for scanning frequency is to be executed by the receiver, the user inputs the select number, which is registered in the link table, by the input unit 13 and inputs the instruction of scanning start by the operation unit 14 (step S10). When the select number is input in order to execute frequency scanning, the number of the frequency bands which correspond to the select number and are registered in the link table is stored as N in the RAM. For example, N=3 is stored in the RAM when the select number 1 of FIG. 3 is input, N=2 is stored in the RAM when the select number 8 is input, and N=5 is stored in the RAM when the select number 12 is input.

In response to the instruction of scanning start, the control unit 10 sets 1 as i which represents the order of the link number corresponding to the input select number and stored in the link table (i=1) (step S20). Herein, the order i stored in the link table may be imparted to the link numbers in the order of inputting the frequency bands, may be imparted to the link numbers after they are sorted in the descending order or the ascending order of the frequencies of the frequency bands thereof, or the order may be set for the frequency bands by the user. The determination that whether the frequency bands are higher or lower than one another may be based on the upper-limit frequencies or the lower-limit frequencies of the frequency bands or may be based on center frequencies of the frequency bands, wherein the center frequencies are calculated from the upper-limit frequencies and the lower-limit frequencies thereof.

Subsequently, the control unit 10 reads the lower-limit frequency of the frequency band of the link number of the order i as a frequency in the band table (step S30) and causes the frequency synthesizer 16 to generate the frequency for receiving the signal of the frequency corresponding to the frequency data thereof.

The reception unit 18 receives and demodulates reception signals via the antenna 17 in the frequencies generated by the frequency synthesizer 16. The control unit 10 displays the reception frequency at this point in the display unit 11 (step S40).

The control unit 10 checks a scanning stop condition, and stops scanning when the scanning stop condition is satisfied (step S50: YES). Whether the scanning stop condition is satisfied or not is determined by checking whether the received signal intensity is equal to or more than a predetermined value or not. When the received signal intensity is equal to or more than the predetermined value, scanning is stopped since the scanning stop condition is satisfied.

After the scanning is stopped, scanning may be started again when predetermined time elapses or when a scanning start switch is pressed down. In this case, the process is started from step S60.

Although it is not shown, the scanning can be stopped by a scanning stop instruction.

On the other hand, when the scanning stop condition is not satisfied (step S50: NO), and when predetermined time elapses after the reception is started (step S60: YES), the value of TS read in the band table is added to the frequency data to set new frequency data (step S70), and whether the new frequency data exceeds the upper-limit frequency of the frequency band, which is being scanned, or not is determined (step S80).

If the new frequency data is not exceeding the upper-limit frequency of the frequency band, which is being scanned, (step S80: NO), the frequency synthesizer 16 is caused to generate the frequency for receiving the signal of the frequency corresponding to the frequency data obtained in step S70. The reception unit 18 receives and demodulates a reception signal via the antenna 17 in the frequency generated by the frequency synthesizer 16. The control unit 10 displays the reception frequency in the display unit 11 (step S90).

After step S90, the control unit 10 checks the scanning stop condition and stops scanning if the scanning stop condition as described above is satisfied (step S100: YES). After the scanning is stopped, scanning may be started again when predetermined time elapses or when a scanning start switch or the like is pressed down. Also in this case, the process is started from step S60.

On the other hand, when the scanning stop condition is not satisfied (step S100: NO), the process is returned to step S60.

When the predetermined time has not elapsed in step S60, the scanning stop condition is checked in the process of step S100.

In the process of step S80, when the new frequency data exceeds the upper limit of the frequency band, which is being scanned, (step S80: YES), 1 is added to the order i (step S110). The control unit 10 checks whether the new order i obtained by the addition is equal to or less than the number N of the link numbers, i.e., the frequency bands specified by the select number (step S120).

When the new order i is equal to or less than the number N of the link numbers (step S120: YES), the lower-limit-value frequency of the frequency band corresponding to the new order i is read and set as frequency data (step S130), and the process is transferred to step S90. In the check in step S120, when the new order i is exceeding the number N of the link numbers, i.e., the frequency bands specified by the select number (step S120: NO), the scanning is ended.

Note that, although it is not shown, when the scanning is ended, scanning may be automatically started again from the process of step S20. In this case, all the frequency bands corresponding to the select number can be repeatedly scanned.

Alternatively, scanning may be started again when a scanning start instruction is given after the scanning is ended.

Note that, when scanning is started again based on the instruction from the user after the scanning is stopped, continuous frequency scanning can be carried out by starting from the process of step S60.

In the receiver of the present embodiment described above, the plurality of frequency bands are registered in the band table, and the frequency bands for carrying out frequency scanning are specified by the link table; therefore, the rewriting frequency of the band table is reduced, the codes for carrying out scanning are not required to be attached to the band table, and the plurality of frequency bands can be readily scanned.

The present invention can provide the method for scanning frequency, the receiver, and the recording medium capable of readily carrying out scanning of a plurality of patterns.

Various embodiments and changes may be made thereunto without departing from the broad spirit and scope of the invention. The above-described embodiment is intended to illustrate the present invention, not to limit the scope of the present invention. The scope of the present invention is shown by the attached claims rather than the embodiment. Various modifications made within the meaning of an equivalent of the claims of the invention and within the claims are to be regarded to be in the scope of the present invention.

This application is based on Japanese Patent Application No. 2008-143932 filed on May 30, 2008 and including specification, claims, drawings and summary. The disclosure of the above Japanese Patent Application is incorporated herein by reference in its entirety.

What is claimed is:

1. A receiver comprising:
a reception unit receiving a signal;
a storage unit storing a band table, in which a plurality of frequency bands serving as scanning targets are registered so that the frequency bands correspond to band identifiers, respectively, and a link table, in which any number of the band identifiers registered in the band table are registered so that the band identifiers correspond to a link identifier; and
a scanning unit which, when the link identifier is specified, refers to the band table and the link table, obtains any number of frequency bands corresponding to the link identifier, sets a reception frequency of the reception unit within each of the frequency bands, and carries out scanning for each of the frequency bands.

2. The receiver according to claim 1, wherein, when scanning within the frequency band is carried out for each of the frequency bands with respect to the specified link identifier, the scanning unit switches the frequency bands of the scanning targets in the order that the band identifiers are registered in the link table.

3. The receiver according to claim 1, wherein, when scanning within the frequency band is carried out for each of the frequency bands with respect to the specified link identifier, the scanning unit switches the frequency bands of the scanning targets in the order instructed in advance.

4. The receiver according to claim 1, wherein redundantly registering the same band identifiers corresponding to the same link identifier is prohibited.

5. The receiver according to claim 1, wherein redundantly registering the same band identifiers corresponding to the same link identifier is permitted.

6. The receiver according to claim 4, wherein
each of the band identifiers is a number; and,
when scanning within the frequency band is carried out for each of the frequency bands with respect to the specified identifier, the scanning unit switches the frequency bands of the scanning targets in the ascending order or descending order of the band identifiers.

7. The receiver according to claim 4, wherein when scanning within the frequency band is carried out for each of the frequency bands with respect to the specified link identifier, the scanning unit switches the frequency bands of the scanning targets in the ascending order or descending order of frequencies of the frequency bands.

8. The receiver according to claim 1, wherein a scanning width is set for each of the frequency bands.

9. A method for scanning frequency, which scans a desired frequency band, the method including:
referring to a band table, in which a plurality of frequency bands serving as scanning targets are registered so that the frequency bands correspond to band identifiers, respectively, and a link table, in which any number of the band identifiers registered in the band table are registered so that the band identifiers correspond to a link identifier; and,
when the link identifier is specified, obtaining the frequency bands corresponding to the link identifier and carrying out scanning within the frequency band for each of the frequency bands.

10. A method for scanning frequency executed by a receiver having a reception unit, a storage unit, and a scanning unit, the method including:
a reception step of receiving a signal received by the reception unit;
a storage step of storing a band table, in which a plurality of frequency bands serving as scanning targets are registered so that the frequency bands correspond to band identifiers, respectively, and a link table, in which any number of the band identifiers registered in the band table are registered so that the band identifiers correspond to a link identifier, the storage step carried out by the storage unit; and
a scanning step of, when the link identifier is specified, referring to the band table and the link table, obtaining any number of frequency bands corresponding to the link identifier, setting a reception frequency of the reception unit within each of the frequency bands, and carrying out scanning for each of the frequency bands, the scanning step carried out by the scanning unit.

11. A computer-readable recording medium recording a program for causing a computer to function as:
a reception unit receiving a signal;
a storage unit storing a band table, in which a plurality of frequency bands serving as scanning targets are registered so that the frequency bands correspond to band identifiers, respectively, and a link table, in which any number of the band identifiers registered in the band table are registered so that the band identifiers correspond to a link identifier; and
a scanning unit which, when the link identifier is specified, refers to the band table and the link table, obtains any number of frequency bands corresponding to the link identifier, sets a reception frequency of the reception unit within each of the frequency bands, and carries out scanning for each of the frequency bands.
